(19) United States
(12) Patent Application Publication
(10) Pub. No.: US 2003/0220784 A1
(43) Pub. Date: Nov. 27, 2003

(54) System and method for automated voice message transcription and delivery

(75) Inventors: Craig William Fellenstein, Brookfield, CT (US); Rick Allen Hamilton II, Charlottesville, VA (US); Timothy Moffett Waters, Richmond, VA (US)

Correspondence Address: Joseph T. Van Leeuwen, P.O. Box 81641, Austin, TX, 78708-1641, US

(73) Assignee: International Business Machines Corporation, Armonk, NY (US)

(21) Appl. No.: 10/156,781

(22) Filed: May 24, 2002

(51) Int. Cl. G10L 21/00

(52) U.S. Cl. 704/201

(57) ABSTRACT

A system and method for automated voicemail message transcription and delivery is presented. Processing retrieves a voicemail message from a caller and converts the voicemail message to a formatted audio voicemail message and a formatted text message. The formatted audio voicemail message is compared with caller profile audio keywords located in one or more caller profiles. If processing determines a match between the formatted audio voicemail message and one or more caller profile audio keywords, processing retrieves caller information corresponding to a matched caller profile and sends a transmittal message which includes the caller information and the formatted text message to a recipient's forwarding address. Processing may receive a reply message corresponding to the transmittal message and forward the reply message, either as a text message or audio message, to the caller.

### BACKGROUND OF THE INVENTION

1. Technical Field

The present invention relates in general to a system and method for receiving a voicemail message. More particularly, the present invention relates to a system and method for transcribing a voicemail message and using a text based messaging system to deliver the transcribed message.

2. Description of the Related Art

In today's fast paced world, a person uses multiple systems for communication. For example, a businessperson typically uses a stationary phone, a mobile phone, a pager, and email to communicate with customers and other professionals within his organization. The businessperson may have messages on each communication system which include information and requests. A challenge found with using multiple communication systems is the ability to independently manage each communication system. Using the example described above, the businessperson accesses his voicemail system to retrieve voicemail messages and accesses his email system to retrieve email messages.

In addition, a caller may leave a voicemail message that requests an electronic document (i.e. brochure). In this case, the businessperson is required to have the requesting customer's email address in order to fulfill the request. Using voicemail as a communication system has many challenges. For example, a caller leaving a message may assume that the recipient knows the caller's identity and the caller's phone number. Another example is the caller may inadvertently leave the wrong return phone number on the voicemail.

Businesses are moving towards text based communication systems for a variety of reasons. First, business people have a vast amount of information on computer systems. It is convenient to “cut-and-paste” information in an email or to send electronic documents using email. Second, text-based communication systems timestamp messages and leave paper trails. Paper trails may a viable reference if questions arise as to what was actually requested, when it was requested, and who was aware of the request. Third, text-based communication systems allow a user to send a single message to multiple recipients simultaneously. Each recipient may then send a response and copy each person on the original message.

A challenge found with text-based communication systems is that they are not always convenient. For example, a user may be driving in a car and only be able to use a mobile phone for communication. In order to send an email, a user requires a connection to his email service provider. In areas outside a user's typical work area, accessing a connection may be difficult. Wireless email connections are available today to assist a user in accessing email in a mobile environment. However, the lack of wireless email coverage and the slow connection speeds may make wireless email services undesirable. What is needed, therefore, is a way to convert voicemail messages into text messages and forward the text message to a user's text-based communication system.

### SUMMARY

It has been discovered that a transcription manager may be used to convert a voicemail message to a text message, identify a voicemail caller, and send the text message with caller information to a text-based messaging system. A transcription system converts a voicemail message to a text message and a formatted audio message. The formatted audio message is compared with caller profile keywords to determine the caller corresponding to the voicemail message. The transcription system sends the text message to a recipient address based upon address location information included in the recipient's personal profile.

The transcription manager identifies that a voicemail message resides in a voicemail storage area. The transcription manager retrieves the voicemail message and converts the voicemail message to a text message and a formatted audio voicemail message. For example, the voicemail message may be converted to an ASCII text file and an MP3 formatted audio stream.

Caller profiles are stored in a caller profile storage area. Each caller profile corresponds to a caller and includes identification information of the caller, such as audio samples of the caller's voice, the caller's phone numbers, and the caller's address information. The transcription manager selects audio samples in a caller profile and compares the caller profile audio samples with the formatted audio voicemail message. If the transcription manager determines a match between the audio samples and the formatted audio voicemail message, the corresponding caller profile is acknowledged as the identified caller profile.

On the other hand, if the transcription manager does not determine a match between the caller profile audio samples and the formatted audio voicemail message, the transcription manager selects the next caller profile and performs a comparison using the next caller's audio samples. The transcription manager continues to compare audio samples from different caller profiles to the formatted audio voicemail message until a match is determined or there are no more caller profiles to compare, in which case the transaction manager creates a new caller profile.

The transcription manager analyzes the text message and identifies keywords, such as nouns and pronouns. The transcription manager locates corresponding keywords in the formatted audio voicemail message and stores the formatted audio keywords in the identified caller's profile. These formatted audio keywords are used to increase the probability of a proper match when analyzing future formatted audio voicemail messages.

Processing retrieves personal profile information which includes information as to where to forward the text message. The transcription manager adds information from the identified caller profile to the text message and sends the text message with caller information to the recipient. The recipient receives the message and makes a determination as to whether to reply to the message. If the recipient chooses to reply to the message, the recipient sends a text reply to the transcription manager.

The transcription manager receives the text reply and retrieves the corresponding identified caller profile corresponding to the original text message. The transcription manager identifies whether the text reply should be converted to a voice reply (i.e. voicemail message) or sent as a text message. If the message should be converted to a voice reply, the transcription manager uses information in the identified caller profile to select the proper address location of the corresponding voice reply (i.e. voicemail phone number). The transcription manager converts the text reply to a voice reply using a voice synthesizer system and sends the voice reply to the caller's corresponding voicemail system.

If the text reply should be sent as a text message to the caller, the transcription manager selects the proper address location and sends the text message to the corresponding address.

In one embodiment, the transcription manager may have the ability to convert the text reply into a voice reply using a different language. For example, the transcription manager may have the ability to convert an English text message into a French voicemail message.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a high-level diagram showing a user receiving a message from a caller using a text based messaging system;

FIG. 2 is a high-level flowchart showing steps taken in identifying a caller corresponding to a voicemail message and forwarding the voicemail message as a text message;

FIG. 3 is a flowchart showing steps taken in converting a voicemail message to a text message and locating keywords in the text message;

FIG. 4 is a flowchart showing steps taken in converting a voicemail message to a formatted audio stream and identifying a caller corresponding to the voicemail message;

FIG. 5 is a flowchart showing steps taken in sending a text message to a recipient;

FIG. 6 is a flowchart showing steps taken in replying to a text message using a text-based system or an audio-based system; and

FIG. 7 is a block diagram of an computer product capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

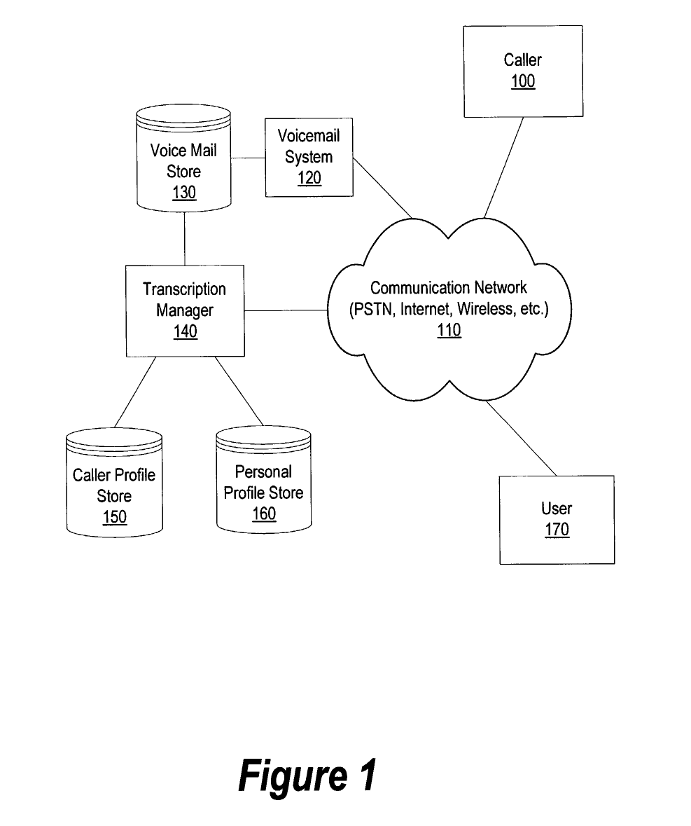

FIG. 1 is a high-level diagram showing a user receiving a message from a caller using a text based messaging system. Caller 100 connects with voicemail system 120 through communication network 110, such as the public switch telephone network (PSTN) or Internet. Voicemail system 120 may be a hardware or software system that is capable of managing voicemail messages. Caller 100 uses voicemail system 120 to leave a message for user 170 on voicemail store 130. Voicemail store 130 may be stored on a non-volatile storage area, such as a computer hard drive.

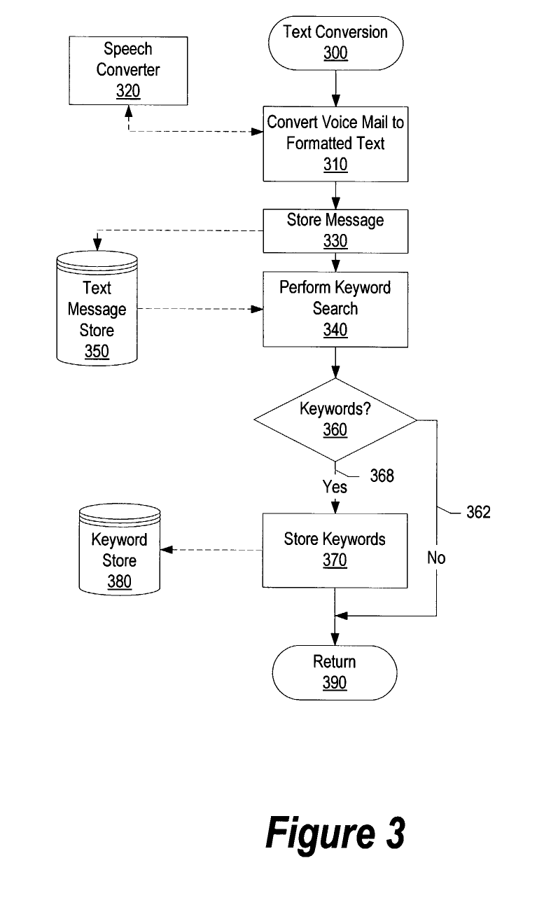

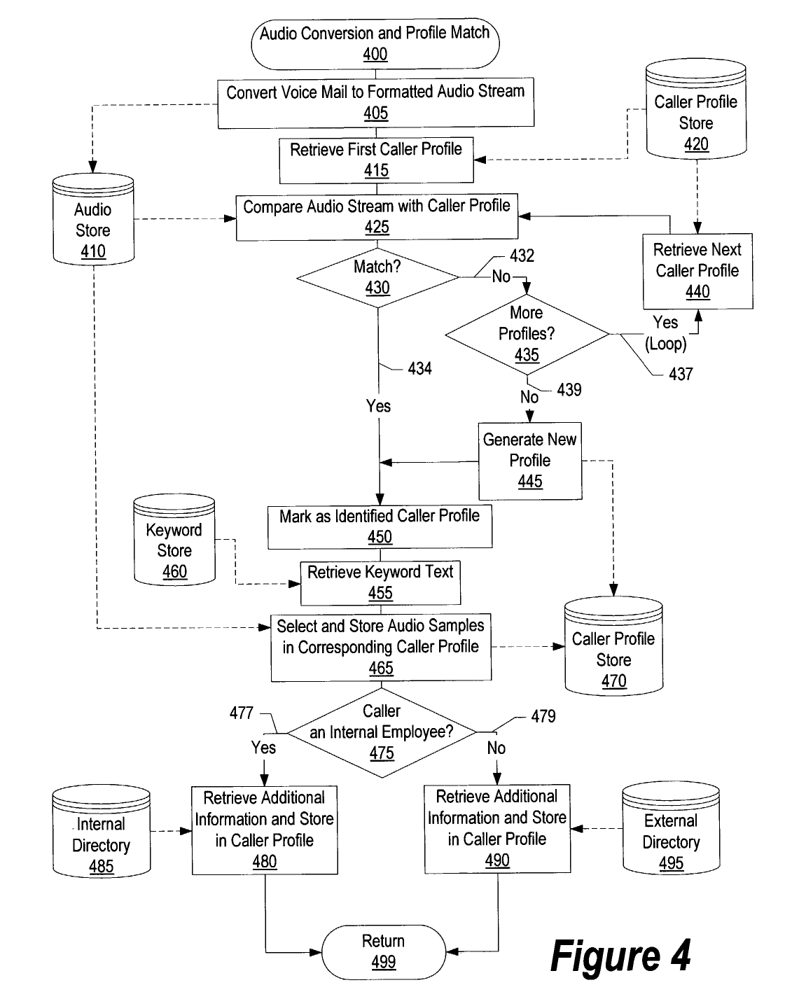

Transcription manager 140 identifies that a voicemail message addressed to user 170 resides on voicemail store 130. Transcription manager 140 retrieves the voicemail message and converts the voicemail message to a text message (see FIG. 3 and corresponding text for further details regarding voicemail conversion to text). Transcription manager 140 also converts the voicemail message to a formatted audio stream (see FIG. 4 and corresponding text for further details regarding voicemail conversion to a formatted audio stream). For example, the voicemail message may be converted to an ASCII text file and an MP3 formatted audio stream.

Transcription manager 140 retrieves a first caller profile located in caller profile store 150. Each caller profile corresponds to a caller and includes identification information of the caller, such as audio samples of the caller's voice, the caller's phone numbers, and the caller's address information. Transcription manager 140 selects audio samples in the first caller profile and compares the audio samples with the formatted audio voicemail message. If transcription manager 140 determines a match between the audio samples and the formatted audio voicemail message, the corresponding caller profile is acknowledged as the identified caller profile (see FIG. 4 and corresponding text for further details regarding audio sample comparison). Using the example described above, the MP3 formatted audio stream may match with user 170's manager caller profile.

On the other hand, if transcription manager 140 does not determine a match between the audio samples and the formatted audio voicemail message, transcription manager 140 retrieves the next caller profile located in caller profile store 150. If transcription manager is not able to determine a match after analyzing each caller profile located in caller profile store 150, transcription manager creates a new caller profile for caller 100.

Transcription manager 140 analyzes the text message and identifies keywords, such as nouns and pronouns. Transcription manager 140 locates the corresponding keywords in the formatted audio voicemail message and stores the formatted audio keywords in the identified caller's caller profile. These formatted audio keywords are used to increase the probability of a proper match when analyzing future formatted audio voicemail messages.

Processing retrieves personal profile information from personal profile store 160 which includes information as to where to forward the text message. In one embodiment, the personal profile information may identify a number of priority callers and may specify a priority method of sending a priority caller message. Using the example described above, the message handing information may instruct transcription manager 140 to send the text message to user 170's text pager since the corresponding voicemail message is from user 170's manager.

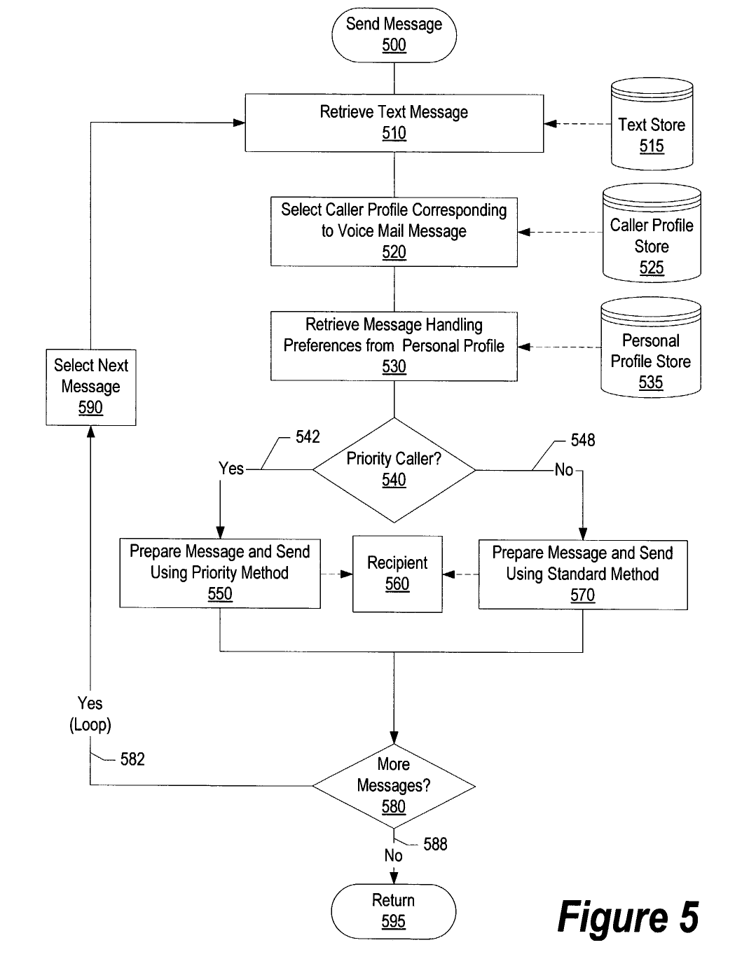

Transcription manager 140 adds information from the identified caller profile to the formatted text message and sends it to user 170 through network 110, such as a wireless network or the Internet (see FIG. 5 and corresponding text for further details regarding message sending). User 170 receives the message and makes a determination as to whether to reply to the message. If user 170 chooses to reply to the message, user 170 sends a text reply to transcription manager 140 through communication network, such as a wireless network or the Internet.

Transcription manager 140 receives the text reply and retrieves the corresponding identified caller profile. Transcription manager 140 identifies whether the text reply should be converted to a voice reply (i.e. voicemail message) or sent as a text message. If the message should be converted to a voice reply, transcription manager 140 uses information in the identified caller profile to select the proper address location of the corresponding voice reply (i.e. voicemail phone number). Transcription manager 140 converts the text reply to a voice reply using a voice synthesizer system and sends the voice reply to caller 100's corresponding voicemail system.

In one embodiment, transcription manager 140 may have the ability to convert the text reply into a voice reply using a different language. Using the example described above, user 170's manager may be French and user 170 may instruct transcription manager 140 to convert the English text reply to a French voice reply.

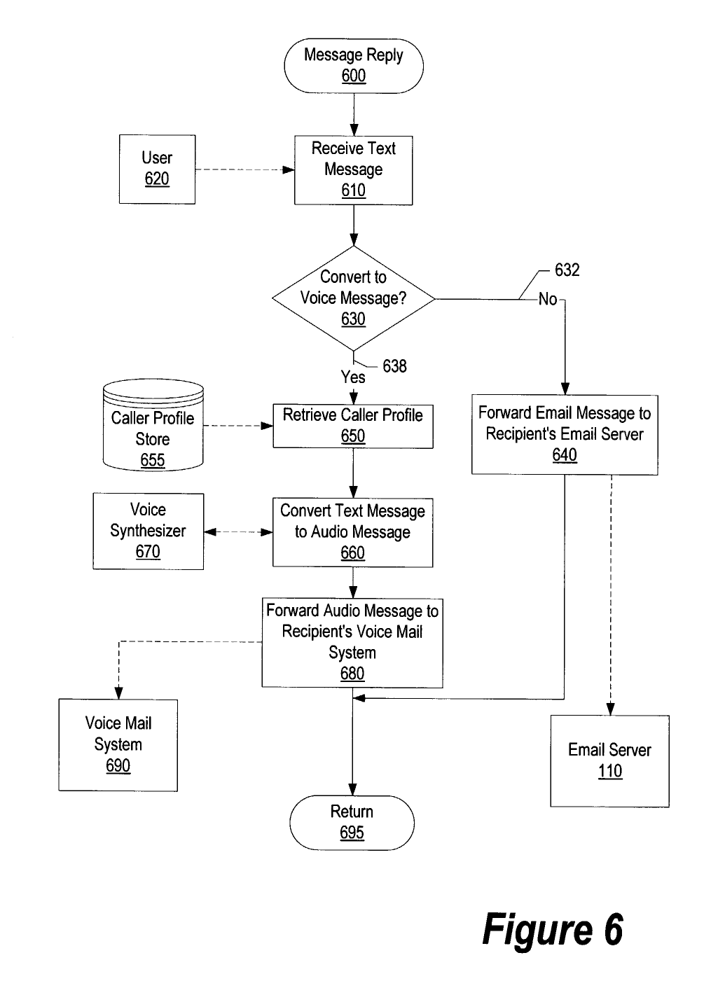

If the text reply should be sent as a text message to caller 100, transcription manager 140 selects the proper address location and sends the text message to the corresponding address (see FIG. 6 and corresponding text for further details regarding message replies).

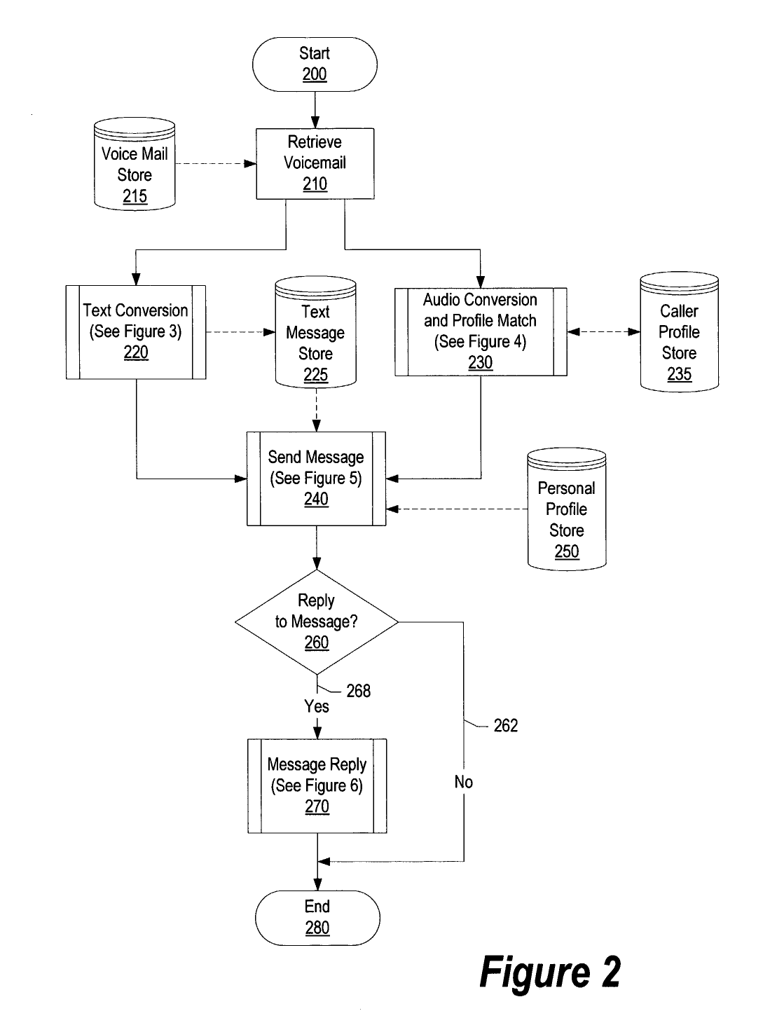

FIG. 2 is a high-level flowchart showing steps taken in identifying a caller corresponding to a voicemail message and forwarding the voicemail message as a text message. Processing commences at 200, whereupon a voicemail message is retrieved from voicemail store 215 (step 210). Voicemail store 215 may be stored on a non-volatile storage area, such as a computer hard drive. Two processes occur with the retrieved voicemail message. The first process is converting the voicemail message to a text-based format and storing the text message in text message store 225 (pre-defined process block 220, see FIG. 3 and corresponding text for further details). For example, processing may convert the voicemail message to an ASCII text message. Text message store 225 may be stored on a non-volatile storage area, such as a computer hard drive.

The second process that occurs with the retrieved voicemail message is converting the voicemail message to a formatted audio stream and identifying a caller corresponding to the voicemail message using caller profiles in caller profile store 235 (pre-defined process block 230, see FIG. 4 and corresponding text for further details). For example, processing may convert the voicemail message to an MP3 formatted audio stream.

Once both processes occur, the text message is sent to a recipient address described in personal profile store 250. Personal profile store 250 includes information regarding forwarding address locations. For example, the text message may be forwarded to an electronic mail server, a text page messaging service, or a text based mobile phone service. The forwarding process may be unique to the caller corresponding to the voicemail message. Using the example described above, priority caller messages may be sent to the recipient's text page messaging service and non-priority caller messages may be sent to the recipient's electronic mail server. Customization of personal profile store 250 may be performed using a web-based interface with a user id and password. Personal profile store 250 may be stored on a non-volatile storage area, such as a computer hard drive. Using the example described above, the text message may be sent to a recipient's email system.

A determination is made as to whether the message recipient wishes to reply to the corresponding message (decision 260). If the message recipient does not choose to reply to the corresponding message, decision 260 branches to “No” branch 262 bypassing message reply steps. On the other hand, if the message recipient chooses to reply to the corresponding message, decision 260 branches to “Yes” branch 268 whereupon message reply processing occurs (pre-defined process block 270, see FIG. 6 and corresponding text for further details). Processing ends at 280.

FIG. 3 is a flowchart showing steps taken in converting a voicemail message to a text message and locating keywords in the text message. Text conversion processing commences at 300, whereupon a voicemail message is converted to a text-based message using speech converter 320 (step 310). Speech converter 320 may be a speech recognition software program that has the ability to convert speech into text. For example, speech conversion may convert a voicemail message into an ASCII text message. The text message is stored in text message store 350 at step 330. Text message store 350 may be stored on a non-volatile storage area, such as a computer hard drive.

A keyword search is performed on the stored text message which may be used to locate formatted audio samples to store in a caller's profile (see FIG. 4 and corresponding text for further information regarding storing formatted audio samples). For example, the keyword search may search for nouns, pronouns, and verbs in the text message. A determination is made as to whether one or more keywords were located (decision 360). If no keywords were located, decision 360 branches to “No” branch 362 bypassing keyword storage steps. On the other hand, if keywords were found, decision 360 branches to “Yes” branch 368 whereupon the keywords are stored in keyword store 380 (step 370). Keyword store 380 may be stored on a non-volatile storage area, such as a computer hard drive. Processing returns at 390.

FIG. 4 is a flowchart showing steps taken in converting a voicemail message to a formatted audio stream and identifying a caller corresponding to the voicemail message. Processing commences at 400, whereupon a voicemail message is converted to a formatted audio voicemail message and stored in audio store 410 (step 405). For example, the voicemail message may be converted to an MP3 formatted audio stream and stored in audio stream 410. Audio stream 410 may be stored on a non-volatile storage area, such as a computer hard drive. A first caller profile is retrieved from caller profile store 420 at step 415. Each caller profile includes information about a particular caller, such as formatted audio keywords spoken by the caller, caller ID information (i.e. phone number), the caller's addresses, and the caller's name.

The formatted audio voicemail message is retrieved from audio store 410 and compared with formatted audio keywords located in the first caller profile at step 425. A determination is made as to whether the formatted audio voicemail message matches the formatted audio keywords corresponding to the first caller profile (decision 430). If the formatted audio voicemail message does not match the formatted audio keywords corresponding to the first caller profile, decision 430 branches to “No” branch 432 whereupon a determination is made as to whether there are more caller profiles in caller profile store 420 (decision 435). If there are more caller profiles in caller profile store 420, decision 435 branches to “Yes” branch 437 which loops back to retrieve (step 440) and process the next caller profile. This looping continues until there are no more caller profiles to process in caller profile store 420, at which point decision 435 branches to “No” branch 439 whereupon a new caller profile is generated in caller profile store 470. Caller profile store 470 may be stored on a non-volatile storage area, such as a computer hard drive. In one embodiment, the new caller profile generation may retrieve caller ID information from the voicemail message. For example, if the caller is calling from his home or he is using a mobile phone, the caller's name and phone number may be stored with the corresponding voicemail message in a voicemail storage area.

If the formatted audio voicemail message matches the formatted audio keywords corresponding to a caller profile, decision 430 branches to “Yes” branch 434 whereupon the corresponding caller profile is acknowledged as an identified caller profile (step 450). Keyword text corresponding to the voicemail message is retrieved from keyword store 460 at step 455 (see FIG. 3 and corresponding text for further details regarding keyword text). Processing selects formatted audio samples from audio store 410 and stores the formatted audio samples in the identified caller's profile in caller profile store 470 (step 465). Adding formatted audio samples to the caller's profile increase the probability of a future correct voicemail message match by having more formatted audio samples to compare with the formatted audio voicemail message.

A determination is made as to whether the caller is an internal employee at decision 475 (i.e. works for the same company). If the caller is an internal employee, decision 475 branches to “Yes” branch 477 whereupon processing retrieves additional information from internal directory 485 and stores the information in the identified caller's profile. Internal directory 485 may be stored on a non-volatile storage area, such as a computer hard drive. For example, internal directory 485 may include the caller's email address, internal mailbox location, and work phone number.

On the other hand, if the caller is not an internal employee, decision 475 branches to “No” branch 479 whereupon processing retrieves additional information corresponding to the caller from external directory 495 and stores the information in the identified caller's profile. External directory 495 may be a web-based yellow pages and may be stored on a non-volatile storage area, such as a computer hard drive. Processing returns at 499.

FIG. 5 is a flowchart showing steps taken in sending a text message to a recipient. Processing commences at 500, whereupon a text message is retrieved from text store 515 (step 510). The text message is a voicemail message converted to a text message (see FIG. 3 and corresponding text for further details regarding voicemail message conversion). For example, the text message may be an urgent message from the recipient's manager. Text store 515 may be stored on a non-volatile storage area, such as a computer hard drive. An identified caller profile corresponding to the text message is selected from caller profile store 525 at step 520 (see FIG. 4 and corresponding text for further details regarding caller identification). Using the example described above, the manager's caller profile is selected from caller profile store 525.

Processing retrieves message handling information from personal profile store 535 at step 530. Message handling information includes the address location of where to send the text message based upon the corresponding identified caller profile. Message handling information may have a list of callers, such as priority callers, in which messages from these callers are handled differently. Using the example described above, the recipient's message handling information may include information that instructs processing to send each text message from the recipient's manager to the recipient's text pager.

A determination is made as to whether the identified caller profile corresponds to a priority caller (decision 540). If the corresponding voicemail caller is a priority caller, decision 540 branches to “Yes” branch 542 whereupon the text message is sent to recipient 560 using a priority method (step 550). Using the example described above, the text message is sent to the recipient's text pager.

On the other hand, if the identified caller profile does not correspond to a priority caller, decision 540 branches to “No” branch 548 whereupon the text message is sent to recipient 560 using a standard method. For example, the identified caller profile may be a vendor's caller profile and the recipient's message handling information directs processing to send vendor messages to the recipient's email account.

A determination is made as to whether there are more text messages to send to the recipient (decision 580). If there are more text messages to send, decision 580 branches to “Yes” branch 582 which loops back to select (step 590) and process the next message. This looping continues until there are no more messages to send to recipient 560, at which point decision 580 branches to “No” branch 588. Processing returns at 595.

FIG. 6 is a flowchart showing steps taken in replying to a text message using a text-based system or an audio-based system. Processing commences at 600, whereupon a reply text message is received from user 620 at step 610. The reply text message is in response to a text message received by user 620. The reply text message may include information as to whether to convert the reply text message to an audio message.

A determination is made as to whether to convert the text message to an audio message (decision 630). If the text message should not be converted to an audio message, decision 630 branches to “No” branch 632 whereupon the text message is forwarded to email server 645 (e.g. the recipient's email server). On the other hand, if the text message should be converted to an audio message, decision 630 branches to “Yes” branch 638. For example, user 620 may be replying to a French customer who is traveling and does not readily have email access.

The message recipient's caller profile is retrieved from caller profile store 655 at step 650. The message recipient's caller profile may include which language to translate the text message. Using the example described above, the French customer's caller profile may direct processing to translate audio messages into the French language. The text message is converted to an audio message at step 660 using voice synthesizer 670. Voice synthesizer 670 may be a hardware or software system that is capable of translating text messages to audio messages. Using the example described above, voice synthesizer 670 translates the English text message into a French audio message. Processing forwards the audio message to voice mail system 690 at step 680 (e.g. the recipient's voicemail account). Processing returns at 695.

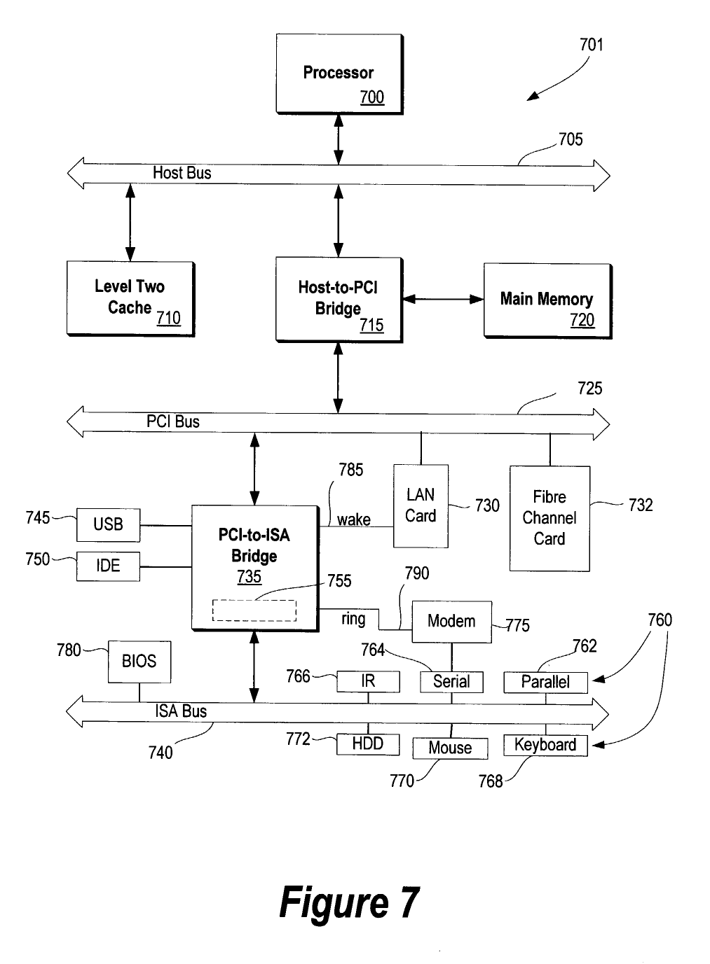

FIG. 7 illustrates information handling system 701 which is a simplified example of a computer system capable of performing the invention described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDF device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (HDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of handling voicemail messages, said method comprising:
retrieving one of the voicemail message, the voicemail message corresponding to a caller;
converting the voicemail message to a formatted audio voicemail message;
matching the formatted audio voicemail message with one or more caller profile audio keywords,
identifying an identified caller profile based on the matching, wherein the identified caller profile corresponds to the caller;
retrieving identified caller information from the identified caller profile;
inserting the identified caller information into a transmittal message;
retrieving a forwarding address corresponding to a recipient; and
sending the transmittal message to the forwarding address.

2. The method as described in claim 1 further comprising:
converting the voicemail message to a formatted text message; and
adding the formatted text message to the transmittal message.

3. The method as described in claim 2 further comprising:
selecting one or more text keywords from the formatted text message,
detecting one or more formatted audio keywords located in the formatted audio voicemail message corresponding to the text keywords; and
storing the formatted audio keywords in the corresponding identified caller profile in response to the detecting.

4. The method as described in claim 1 wherein the formatted audio voicemail message is included in the transmittal message.

5. The method as described in claim 1 further comprising:
retrieving a directory;
locating caller directory information in the directory corresponding to the caller; and
adding the caller directory information to the identified caller profile.

6. The method as described in claim 1 further comprising:
receiving a reply message, the reply message corresponding to the transmittal message;
retrieving a reply address from the identified caller profile; and
sending the reply message to the reply address.

7. The method as described in claim 6 further comprising:
determining whether to convert the reply message to a voice reply message;
converting the reply message to the voice reply message in response to the determination; and
sending the voice reply message to the reply address.

8. An information handling system comprising:
one or more processors;
a memory accessible by the processors;
one or more non-volatile storage devices accessible by the processors;
a voicemail handling tool to handle voicemail messages, the voicemail handling tool including:
means for retrieving one of the voicemail message, the voicemail message corresponding to a caller;
means for converting the voicemail message to a formatted audio voicemail message;
means for matching the formatted audio voicemail message with one or more caller profile audio keywords,
means for identifying an identified caller profile based on the matching, wherein the identified caller profile corresponds to the caller;
means for retrieving identified caller information from the identified caller profile;
means for inserting the identified caller information into a transmittal message;
means for retrieving a forwarding address corresponding to a recipient; and
means for sending the transmittal message to the forwarding address.

9. The information handling system as described in claim 8 further comprising:
means for converting the voicemail message to a formatted text message; and
means for adding the formatted text message to the transmittal message.

10. The information handling system as described in claim 9 further comprising:
means for selecting one or more text keywords from the formatted text message,
means for detecting one or more formatted audio keywords located in the formatted audio voicemail message corresponding to the text keywords; and
means for storing the formatted audio keywords in the corresponding identified caller profile in response to the detecting.

11. The information handling system as described in claim 8 wherein the formatted audio voicemail message is included in the transmittal message.

12. The information handling system as described in claim 8 further comprising:
means for retrieving a directory;
means for locating caller directory information in the directory corresponding to the caller; and
means for adding the caller directory information to the identified caller profile.

13. The information handling system as described in claim 8 further comprising:
means for receiving a reply message, the reply message corresponding to the transmittal message;
means for retrieving a reply address from the identified caller profile; and
means for sending the reply message to the reply address.

14. The information handling system as described in claim 13 further comprising:
means for determining whether to convert the reply message to a voice reply message;
means for converting the reply message to the voice reply message in response to the determination; and
means for sending the voice reply message to the reply address.

15. A computer program product stored in a computer operable media for handling voicemail messages, said computer program product comprising:
means for retrieving one of the voicemail message, the voicemail message corresponding to a caller;
means for converting the voicemail message to a formatted audio voicemail message;
means for matching the formatted audio voicemail message with one or more caller profile audio keywords,
means for identifying an identified caller profile based on the matching, wherein the identified caller profile corresponds to the caller;
means for retrieving identified caller information from the identified caller profile;
means for inserting the identified caller information into a transmittal message;
means for retrieving a forwarding address corresponding to a recipient; and
means for sending the transmittal message to the forwarding address.

16. The computer product as described in claim 15 further comprising:
means for converting the voicemail message to a formatted text message; and
means for adding the formatted text message to the transmittal message.

17. The computer product as described in claim 16 further comprising:
means for selecting one or more text keywords from the formatted text message,
means for detecting one or more formatted audio keywords located in the formatted audio voicemail message corresponding to the text keywords; and
means for storing the formatted audio keywords in the corresponding identified caller profile in response to the detecting.

18. The computer product as described in claim 15 wherein the formatted audio voicemail message is included in the transmittal message.

19. The computer product as described in claim 15 further comprising:
means for retrieving a directory;
means for locating caller directory information in the directory corresponding to the caller; and
means for adding the caller directory information to the identified caller profile.

20. The computer product as described in claim 15 further comprising:
means for receiving a reply message, the reply message corresponding to the transmittal message;
means for retrieving a reply address from the identified caller profile; and
means for sending the reply message to the reply address.

21. The computer product as described in claim 20 further comprising:
means for determining whether to convert the reply message to a voice reply message;
means for converting the reply message to the voice reply message in response to the determination; and
means for sending the voice reply message to the reply address.
